(19) United States
(12) Patent Application Publication
(10) Pub. No.: US 2013/0129021 A1
(43) Pub. Date: May 23, 2013

(54) AUTOMATIC GAIN CONTROLLING DEVICE, ORTHOGONAL FREQUENCY DIVISION MULTIPLEXING (OFDM) RECEIVER EMPLOYING HIGH-ORDER QUADRATURE AMPLITUDE MODULATION (QAM) AND USING AUTOMATIC GAIN CONTROLLING DEVICE, AND MANUFACTURING METHOD OF AUTOMATIC GAIN CONTROLLING DEVICE

(71) Applicants: Jae Ho LEE, Daejeon (KR); Yang Su KIM, Daejeon (KR); Han Seung KOO, Daejeon (KR); Sang Jung RA, Daejeon (KR); Dong Joon CHOI, Daejeon (KR); Nam Ho HUR, Daejeon (KR)

(72) Inventors: Jae Ho LEE, Daejeon (KR); Yang Su KIM, Daejeon (KR); Han Seung KOO, Daejeon (KR); Sang Jung RA, Daejeon (KR); Dong Joon CHOI, Daejeon (KR); Nam Ho HUR, Daejeon (KR)

(73) Assignee: ELECTRONICS AND TELECOMMUNICATIONS RESEARCH INSTITUTE, Daejeon (KR)

(21) Appl. No.: 13/550,969

(22) Filed: Jul. 17, 2012

(30) Foreign Application Priority Data
Nov. 18, 2011 (KR) 10-2011-0120902

(51) Int. Cl. H04L 27/38

(52) U.S. Cl. 375/340

(57) ABSTRACT

Provided is an automatic gain controlling device that may prevent deterioration in performance of an orthogonal frequency division multiplexing (OFDM) receiver, on a cable network that performs communication by an orthogonal frequency division multiplexing (OFDM) scheme using high-order quadrature amplitude modulation (QAM), the automatic gain controlling device including a power computing unit to compute a power of a signal received by the OFDM receiver, and a gain controller to control a gain of the received signal based on the computed power of the received signal.

### CROSS-REFERENCE TO RELATED APPLICATION

This application claims the benefit of Korean Patent Application No. 10-2011-0120902, filed on Nov. 18, 2011, in the Korean Intellectual Property Office, the disclosure of which is incorporated herein by reference.

### BACKGROUND

1. Field of the Invention

The present invention relates to an automatic gain controlling device which may prevent deterioration in performance of an orthogonal frequency division multiplexing (OFDM) receiver, the OFDM receiver employing high-order quadrature amplitude modulation (QAM) and using the automatic gain controlling device, and a manufacturing method of the automatic gain controlling device.

2. Description of the Related Art

Orthogonal frequency division multiplexing (OFDM) may refer to a modulation scheme of multiplexing a high-speed transmission signal into a plurality of orthogonal narrow-band sub-carriers.

That is, the OFDM may refer to a scheme of dividing a data column having a relatively high transmission rate into a plurality of data columns, each data column having a relatively low transmission rate, and transmitting the plurality of data columns simultaneously, using a plurality of orthogonal sub-carriers. Accordingly, the OFDM may be referred to as a multiplexing technology in an aspect that a high-speed source data column of a single channel may be transmitted simultaneously to multiple channels, and may also be referred to as a type of modulation technology in an aspect that the high-speed source data column of the single channel may be divided and transmitted, using multiple carriers.

In this instance, a waveform of each sub-carrier may be orthogonal to one another so that an occurrence of interference may be prevented on a temporal axis, however, may overlap one another on a frequency axis.

Quadrature amplitude modulation (QAM) may refer to a modulation scheme of transmitting data by converting and controlling amplitudes and phases of two independent carriers, that is, a quadrature carrier and an in-phase carrier.

The QAM may refer to a modulation scheme in which amplitude-shift keying (ASK) and phase-shift keying (PSK) are combined, and the two independent carriers, which are generally provided in forms of sine curves, may be in quadrature by 90° with respect to each other. Accordingly, the QAM may be advantageous for high-speed data transmission in a limited transmission band.

The OFDM having a high frequency efficiency may be used to provide a large capacity broadcasting service via a cable network. In this instance, each sub-carrier of the OFDM may modulate data using the QAM. When the QAM and the OFDM are used, an OFDM receiver may be sensitive to a gain of a received signal.

### SUMMARY

According to an aspect of the present invention, there is provided an automatic gain controlling device to be used in an orthogonal frequency division multiplexing (OFDM) receiver, the automatic gain controlling device including a power computing unit to compute a power of a signal received by the OFDM receiver, and a gain controller to control a gain of the signal based on the computed power of the received signal. Here, the signal may include a signal that may be modulated using high-order quadrature amplitude modulation (QAM).

The gain controller may adjust the gain of the signal, based on a reciprocal value of a square root of the computed power of the received signal.

According to another aspect of the present invention, there is provided a receiver to be used on a cable network that performs communication by an OFDM scheme, the receiver including a receiving unit to receive an OFDM carrier signal from a cable channel included in the cable network, and to generate a plurality of constellation mapping signals, based on the received OFDM carrier signal, a gain controller to compute a power of each of the plurality of constellation mapping signals, and to control a gain of each of the plurality of constellation mapping signals, based on the computed power of the received signal, and a symbol determining unit to determine a symbol corresponding to each of the plurality of constellation mapping signals of which the gain is controlled. Here, the OFDM carrier signal may include at least one OFDM sub-carrier signal that may be modulated using high-order QAM.

The gain controller may include a power computing unit to compute the power of each of the plurality of constellation mapping signals, and a gain adjusting unit to adjust the gain of each of the plurality of constellation mapping signals, based on a reciprocal value of a square root of the computed power of the received signal.

The symbol determining unit may select a single symbol, among a plurality of predetermined symbols associated with the high-order QAM, that may be most similar to each of the plurality of constellation mapping signals of which the gain is controlled, in order to determine a symbol corresponding to each of the plurality of constellation mapping signals of which the gain is controlled.

According to still another aspect of the present invention, there is provided a method of manufacturing an automatic gain controlling device to be used in an OFDM receiver, the method including disposing a power computing circuit to receive an output signal of an OFDM receiving circuit, disposing a gain computing circuit to receive an output signal of the power computing circuit, and disposing a gain adjusting circuit to receive the output signal of the OFDM receiving circuit and an output signal of the gain computing circuit, and to be connected to an input end of a symbol determining circuit.

The power computing circuit may compute a power of a received signal, based on the output signal of the OFDM receiving circuit. The gain computing circuit may compute a reciprocal value of a square root of the computed power of the received signal, based on the output signal of the power computing circuit. The gain adjusting circuit may adjust a gain of the received signal, based on the output signal of the OFDM receiving circuit and the output signal of the gain computing circuit.

The output signal of the OFDM receiving circuit may include a signal that may be modulated using high-order QAM.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a system using orthogonal frequency division multiplexing (OFDM) and high-order quadrature amplitude modulation (QAM) according to a conventional art;

FIG. 2 is a diagram illustrating a frame structure configured using OFDM and QAM according to a conventional art;

FIG. 3 is a graph illustrating a probability density function (PDF) of an output of an OFDM receiver when 4-QAM is used in an additive white Gaussian noise (AWGN) channel environment according to a conventional art;

FIG. 4 is a graph illustrating a PDF of an output of an OFDM receiver when 4096-QAM is used in an AWGN channel environment according to a conventional art;

FIG. 5 is a block diagram illustrating an automatic gain controlling device to be used in an OFDM receiver employing high-order QAM according to an embodiment of the present invention;

FIG. 6 is a block diagram illustrating a receiver, employing high-order QAM, to be used on a cable network that performs communication by an OFDM scheme according to an embodiment of the present invention;

FIG. 7 is a diagram to describe a method of manufacturing an automatic gain controlling device to be used in an OFDM receiver employing high-order QAM according to an embodiment of the present invention;

FIG. 8 is a graph illustrating a PDF of an output of an OFDM receiver when 4096-QAM is used in an AWGN channel environment according to an embodiment of the present invention; and

FIG. 9 is a graph to describe a bit error rate (BER) of an OFDM receiver which is improved by an automatic gain controlling scheme when 4096-QAM is used in an AWGN channel environment according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

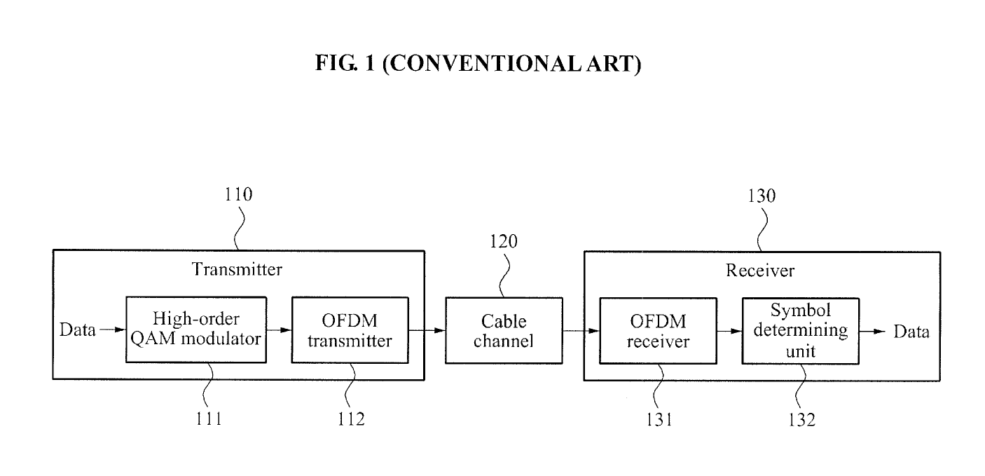

FIG. 1 is a block diagram illustrating a system using orthogonal frequency division multiplexing (OFDM) and high-order quadrature amplitude modulation (QAM) according to a conventional art.

Referring to FIG. 1, a transmitter 110 may include a high-order QAM modulator 111, and an OFDM transmitter 112, and a receiver 130 may include an OFDM receiver 131, and a symbol determining unit 132.

The transmitter 110 may use a plurality of OFDM sub-channels in order to increase a frequency efficiency. In particular, the transmitter 110 may use the plurality of OFDM sub-channels to transmit a plurality of transmit symbols that may be modulated using the high-order QAM.

The high-order QAM modulator 111 included in the transmitter 110 may generate a transmit symbol, by performing constellation mapping on data desired to be transmitted, based on the high-order QAM. The OFDM transmitter 112 included in the transmitter 110 may generate an OFDM carrier to be transmitted through a channel 120, by applying inverse fast Fourier transform (FFT), digital to analog conversion (DAC), and the like to the generated transmit symbol. In this instance, the channel 120 may include a cable channel.

The receiver 130 may estimate and compensate the channel 120, and may determine a received symbol, using the symbol determining unit 132 included in the receiver 130. In order to determine the received symbol, the symbol determining unit 132 may select a single symbol, among a plurality of predetermined symbols associated with the high-order QAM, that may be most similar to the received symbol.

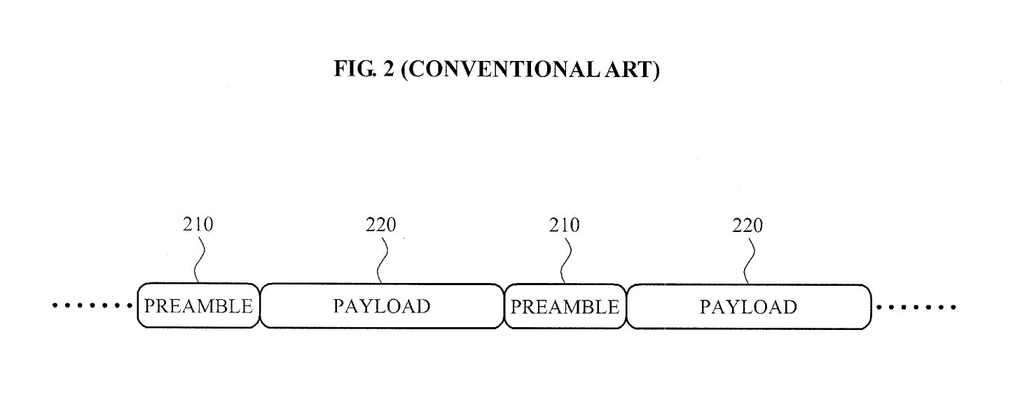

FIG. 2 is a diagram illustrating a frame structure configured using OFDM and QAM according to a conventional art.

Referring to FIG. 2, the frame structure may include a preamble 210, and a payload 220.

Here, the preamble 210 may be used for channel equalization of a receiver, and the payload 220 may be used to modulate data desired to be actually transmitted, based on the high-order QAM, and to transmit the modulated data to each of the plurality of OFDM sub-channels.

That is, an OFDM receiver may perform channel estimation and channel equalization with respect to a cable channel, using the preamble 210. However, an error may occur between the estimated channel and an actual channel. In this instance, an average value of a received symbol that is included in the payload 220 may be changed.

When the average value of the received symbol is changed, the OFDM receiver may determine the received symbol incorrectly. In order to determine the received symbol, a symbol determining unit included in the receiver may select a single symbol, among a plurality of predetermined symbols associated with the high-order QAM, that may be most similar to the received symbol. When the received symbol is to be determined based on a changed average value of the received symbol, the OFDM receiver may incorrectly determine that another symbol differing from the symbol transmitted by a transmitter is received. In this instance, a bit error rate (BER) of the OFDM receiver may increase, and performance of the OFDM receiver may decrease accordingly.

As an order of QAM decreases, an effect of a change in the average value of the received symbol on the BER may decrease. Conversely, as the order of the QAM increases, the effect of the change in the average value of the received symbol on the BER may increase.

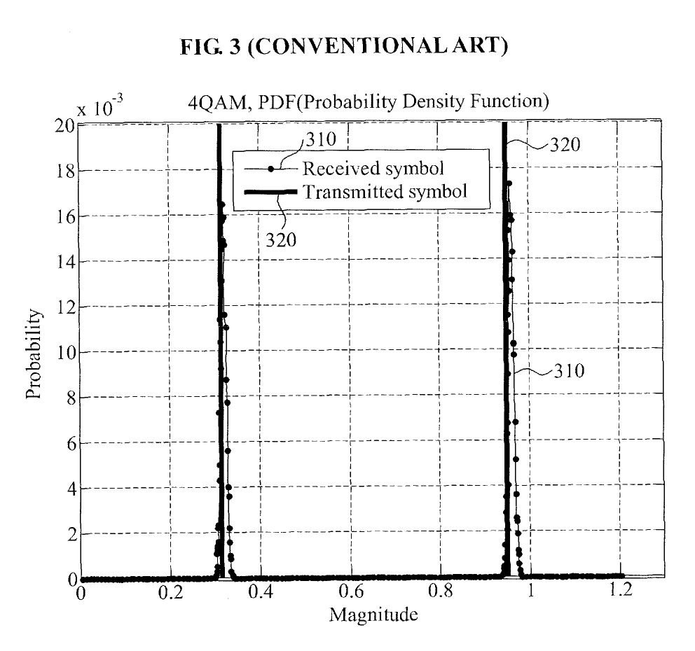

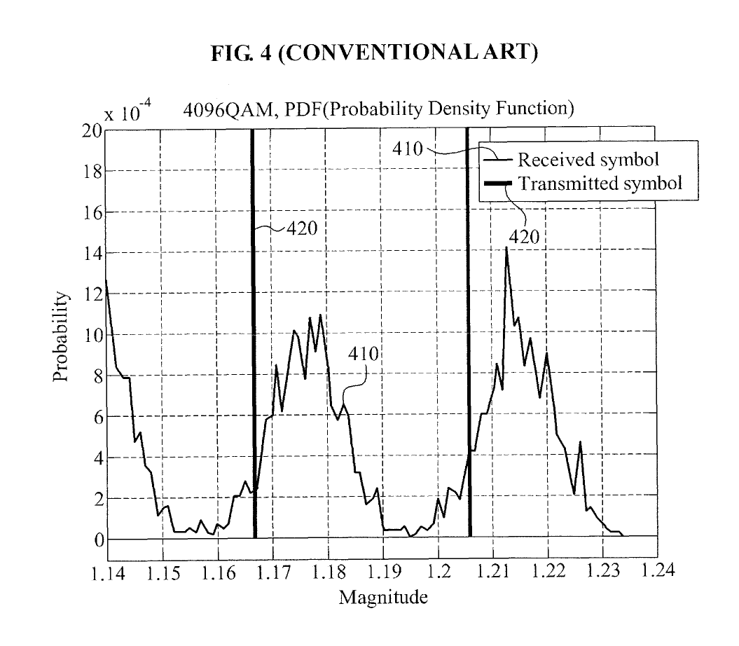

Effects of the changed average value of the received symbol on the BER depending on the order of the QAM will be described with reference to FIGS. 3 and 4.

FIG. 3 is a graph illustrating a probability density function (PDF) of an output of an OFDM receiver when 4-QAM is used in an additive white Gaussian noise (AWGN) channel environment according to a conventional art.

Referring to FIG. 3, when the 4-QAM is used, the PDF of the output of the OFDM receiver may appear in a form in which a portion between −1 and 1 may be divided into four equal intervals. FIG. 3 illustrates two symbols having positive values, among the four equal intervals.

In this instance, an average value of a symbol 310 received by the OFDM receiver in the AWGN channel environment is to be equal to a value of a symbol 320 transmitted by an OFDM transmitter, and the received symbol 310 is to have the Gaussian distribution.

As shown in FIG. 3, although the value of the received symbol 310 has the Gaussian distribution, the average value of the received symbol 310 is out of the value of the transmitted symbol 320. In this instance, a symbol determining unit of the OFDM receiver may incorrectly determine a symbol having the biased average value to be an adjacent symbol.

However, similar to the 4-QAM, when an order of QAM is relatively low, an interval between a plurality of predetermined symbols associated with the QAM may be sufficiently broad. Accordingly, a probability that the symbol determining unit of the OFDM receiver may determine a symbol incorrectly may be relatively low, when compared to a case in which high-order OAM is used.

FIG. 4 is a graph illustrating a PDF of an output of an OFDM receiver when 4096-QAM is used in an AWGN channel environment according to a conventional art.

Referring to FIG. 4, when the 4096-QAM is used, the PDF of the output of the OFDM receiver may appear in a form in which a portion between −1 and 1 may be divided into sixty-four equal intervals. FIG. 4 illustrates two rightmost symbols having positive values, among the sixty-four equal intervals.

Similar to FIG. 3, an average value of a symbol 410 received by the OFDM receiver in the AWGN channel environment is to be equal to a value of a symbol 420 transmitted by an OFDM transmitter, and the value of the received symbol 410 is to have the Gaussian distribution.

As shown in FIG. 4, although the value of the received symbol 410 has the Gaussian distribution, the average value of the received symbol 410 is out of the value of the transmitted symbol 420. In this instance, a symbol determining unit of the OFDM receiver may incorrectly determine a symbol having the biased average value to be an adjacent symbol.

Divergent from the 4-QAM of FIG. 3 and similar to the 4096-QAM of FIG. 4, when an order of QAM is relatively high, an interval between a plurality of predetermined symbols associated with the QAM may be relatively narrow. Accordingly, a probability that the symbol determining unit of the OFDM receiver may determine a symbol incorrectly may be relatively high. That is, a BER of the OFDM receiver may increase in a case in which the 4096-QAM is used, when compared to a case in which the 4-QAM is used.

Accordingly, an automatic gain controlling technology according to an embodiment of the present invention may be applied to the OFDM receiver employing the high-order QAM. The automatic gain controlling technology may reduce an error of the average value of the received symbol, thereby preventing deterioration in performance of the OFDM receiver employing the high-order QAM, which results from the increase of the BER.

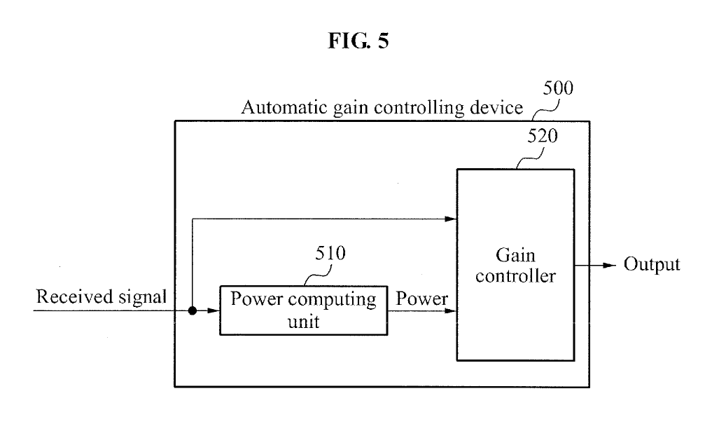

FIG. 5 is a block diagram illustrating an automatic gain controlling device 500 to be used in an OFDM receiver employing high-order QAM according to an embodiment of the present invention.

Referring to FIG. 5, the automatic gain controlling device 500 may include a power computing unit 510, and a gain controller 520.

Here, the power computing unit 510 may compute a power of a signal received by the OFDM receiver, and the gain controller 520 may control a gain of the received signal, based on the computed power of the received signal.

In this instance, the received signal may include a signal that may be modulated using high-order QAM. The power computing unit 510 may compute the power of the received signal, by receiving inputs of data associated with a coordinate I and data associated with a coordinate Q, respectively, on a constellation with respect to the signal modulated using the high-order QAM.

In addition, the gain controller 520 may adjust a gain of the received signal, based on a reciprocal value of a square root of the computed power of the received signal. In particular, the gain controller 520 may adjust the gain of the received signal by multiplying the received signal and the reciprocal value of the square root of the computed power of the received signal.

Also, the OFDM receiver may be used on a cable network, for example, a hybrid fibre-coaxial (HFC) network. In this instance, the signal received by the OFDM receiver may include a signal that may be modulated using the high-order QAM. For example, the received signal may correspond to a signal that may be modulated using 4096-QAM.

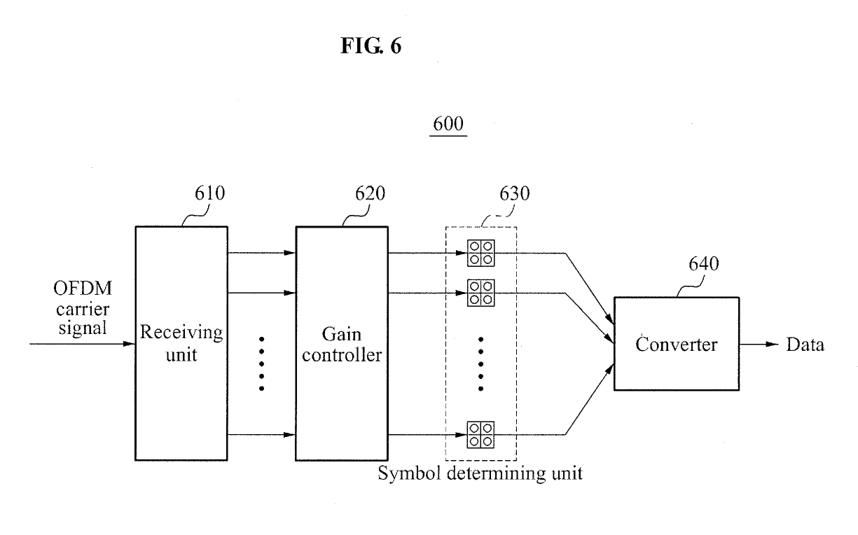

FIG. 6 is a block diagram illustrating a receiver 600, employing high-order QAM, to be used on a cable network that performs communication by an OFDM scheme according to an embodiment of the present invention.

Referring to FIG. 6, the receiver 600 may include a receiving unit 610, a gain controller 620, and a symbol determining unit 630.

The receiving unit 610 may receive an OFDM carrier signal from a cable channel included in the cable network, and may generate a plurality of constellation mapping signals, based on the received OFDM carrier signal. In this instance, the OFDM carrier signal may include at least one OFDM sub-carrier signal that may be modulated using the high-order QAM.

In this instance, the OFDM carrier signal may include the plurality of OFDM sub-carrier signals. The receiving unit 610 may extract information about a transmit symbol from each of the plurality of OFDM sub-carrier signals, and may generate the plurality of constellation mapping signals based on the information extracted about the transmit symbol. That is, the plurality of constellation mapping signals generated by the receiving unit 610 may be dependent on information about the transmit symbol, which may be transmitted using the plurality of OFDM sub-carrier signals.

The gain controller 620 may compute a power of each of the plurality of constellation mapping signals, and may control a gain of each of the plurality of constellation mapping signals, based on the computed power of the received signal.

In this instance, the gain controller 620 may include a power computing unit and a gain adjusting unit.

The power computing unit may compute the power of each of the plurality of constellation mapping signals. In this instance, the power computing unit may compute the power of the received OFDM carrier signal, by receiving inputs of data associated with a coordinate I and data associated with a coordinate Q, respectively, on a constellation with respect to the signal modulated using the high-order QAM.

The gain controller may adjust the gain of each of the plurality of constellation mapping signals, based on a reciprocal value of a square root of the computed power of the received signal. In particular, the gain controller 620 may adjust the gain of the received signal by multiplying the received OFDM carrier signal and the reciprocal value of the square root of the computed power of the received signal.

The symbol determining unit 630 may determine a symbol corresponding to each of the plurality of constellation mapping signals of which the gain is controlled.

In this instance, the symbol determining unit 630 may select a single symbol, among a plurality of predetermined symbols associated with the high-order QAM, that may be most similar to each of the plurality of constellation mapping signals of which the gain is controlled, in order to determine the symbol corresponding to each of the plurality of constellation mapping signals of which the gain is controlled.

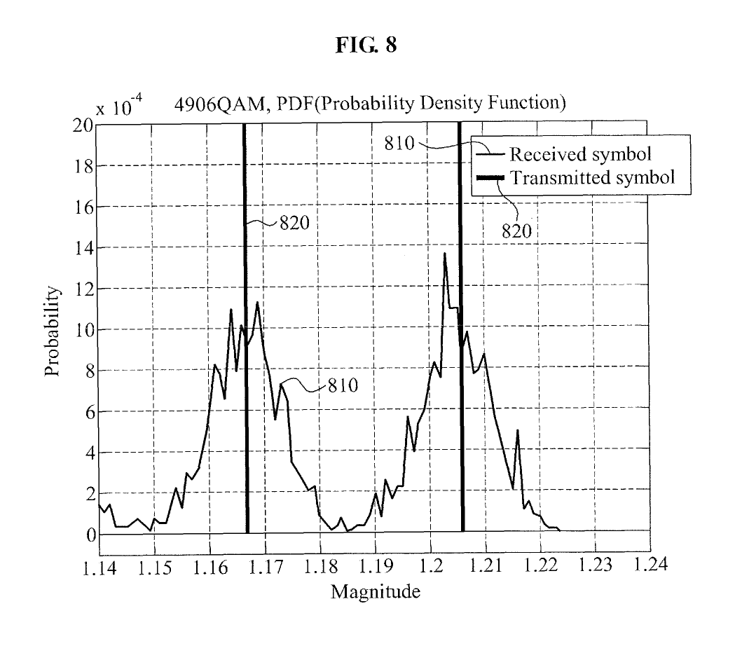

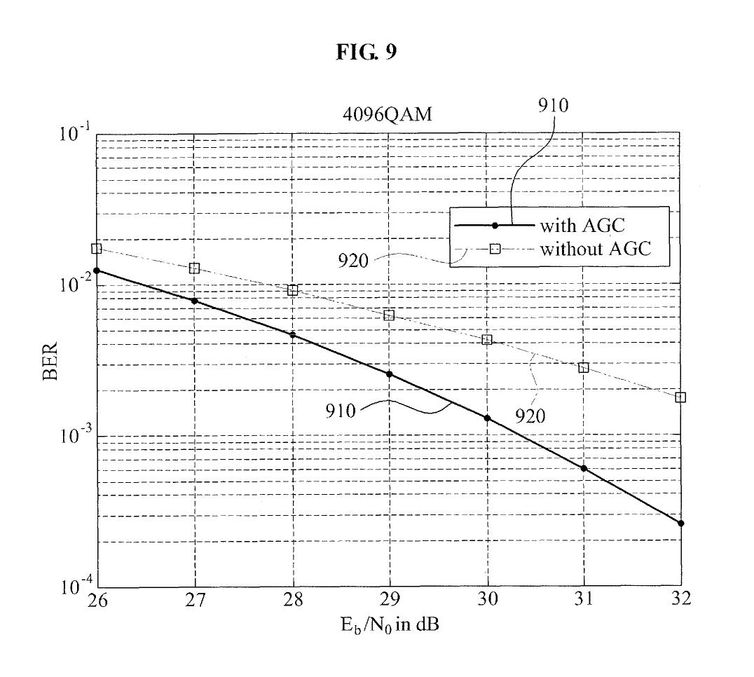

The receiver 600 may adjust, using the gain controller 620, the gain of the received OFDM carrier signal by a reciprocal number of the square root of the computed power of the received OFDM carrier signal, thereby reducing a probability that an error may occur when the symbol determining unit 630 selects a single symbol. Detailed descriptions about effects of an automatic gain controller technology will be described with reference to FIGS. 8 and 9.

In addition, the receiver 600 may further include a converter 640 to convert a parallel signal to a serial signal. When the OFDM is used, a serial signal may be divided into a plurality of parallel signals to be transmitted by a transmitter. Accordingly, the converter 640 may combine the plurality of parallel signals into a single serial signal.

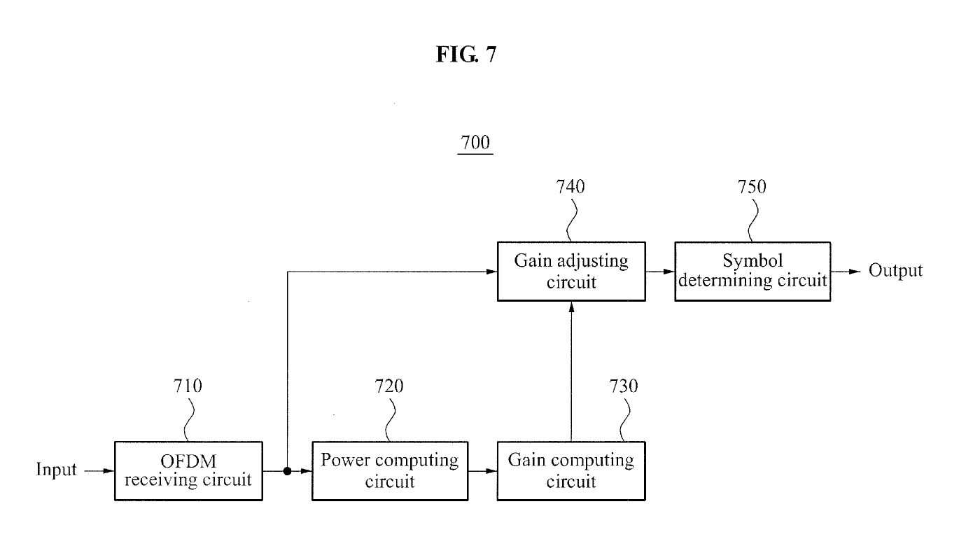

FIG. 7 is a diagram to describe a method of manufacturing an automatic gain controlling device 700 to be used in an OFDM receiver employing high-order QAM according to an embodiment of the present invention.

Referring to FIG. 7, the manufacturing method of the automatic gain controlling device 700 may include disposing a power computing circuit 720, disposing a gain computing circuit 730, and disposing a gain adjusting circuit 740.

Here, in the operation of disposing the power computing circuit 720, the power computing circuit 720 may be disposed to receive an output signal of an OFDM receiving circuit 710. In this instance, the power computing circuit 720 may compute a power of a received signal, based on the output signal of the OFDM receiving circuit 710. The output signal of the OFDM receiving circuit 710 may include a signal that may be modulated using high-order QAM.

In the operation of disposing the gain computing circuit 730, the gain computing circuit 730 may be disposed to receive an output signal of the power computing circuit 720. In this instance, the gain computing circuit 730 may compute a reciprocal value of a square root of the computed power of the received signal, based on the output signal of the power computing circuit 720.

In the operation of disposing the gain adjusting circuit 740, the gain adjusting circuit 740 may be disposed to receive the output signal of the OFDM receiving circuit 710 and an output signal of the gain computing circuit 730, and to be connected to an input end of a symbol determining circuit 750. In this instance, the gain adjusting circuit 740 may adjust a gain of the received signal, based on the output signal of the OFDM receiving circuit 710 and the output signal of the gain computing circuit 730.

The descriptions provided with reference to FIGS. 1 through 6 may be applied identically to each module illustrated in FIG. 7 and thus, detailed descriptions will be omitted for conciseness.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

FIG. 8 is a graph illustrating a PDF of an output of an OFDM receiver when 4096-QAM is used in an AWGN channel environment according to an embodiment of the present invention.

Referring to FIG. 8, when the 4096-QAM is used, the PDF of the output of the OFDM receiver may appear in a form in which a portion between −1 and 1 may be divided into sixty-four equal intervals. FIG. 8 illustrates two rightmost symbols having positive values, among the sixty-four equal intervals.

Similar to FIGS. 3 and 4, an average value of a symbol 810 received by the OFDM receiver in the AWGN channel environment is to be equal to a value of a symbol 820 transmitted by an OFDM transmitter, and the value of the received symbol 810 is to have the Gaussian distribution.

As shown in FIG. 8, although the value of the received symbol 810 has the Gaussian distribution, the average value of the received symbol 810 is similar to the value of the transmitted symbol 820. Accordingly, an automatic gain controlling technology according to an embodiment of the present invention may reduce an error of the average value of the received symbol 810, thereby preventing deterioration in performance of the OFDM receiver employing the high-order QAM resulting from the increase of the BER.

In particular, the OFDM receiver may reduce the error of the average value of the received symbol 810, by adjusting a gain of a received signal by a reciprocal number of a square root of a power of the received signal.

FIG. 9 is a graph to describe a BER of an OFDM receiver which is improved by an automatic gain controlling scheme when 4096-QAM is used in an AWGN channel environment according to an embodiment of the present invention.

Referring to FIG. 9, a BER 910 of the OFDM receiver when the automatic gain controlling technology is applied, and a BER 920 of the OFDM receiver when the automatic gain controlling technology is not applied may be compared.

In FIG. 9, it may be understood that the BER 910 of the OFDM receiver is improved by about 2.2 decibels (dB), when compared to the BER 920 of the OFDM receiver.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An automatic gain controlling device to be used in an orthogonal frequency division multiplexing (OFDM) receiver, the automatic gain controlling device comprising:
a power computing unit to compute a power of a signal received by the OFDM receiver; and
a gain controller to control a gain of the signal based on the computed power of the received signal,
wherein the signal comprises a signal that is modulated using high-order quadrature amplitude modulation (QAM).

2. The automatic gain controlling device of claim 1, wherein the gain controller adjusts the gain of the signal, based on a reciprocal value of a square root of the computed power of the received signal.

3. A receiver to be used on a cable network that performs communication by an orthogonal frequency division multiplexing (OFDM) scheme, the receiver comprising:
a receiving unit to receive an OFDM carrier signal from a cable channel included in the cable network, and to generate a plurality of constellation mapping signals, based on the received OFDM carrier signal;
a gain controller to compute a power of each of the plurality of constellation mapping signals, and to control a gain of each of the plurality of constellation mapping signals, based on the computed power of the received signal; and
a symbol determining unit to determine a symbol corresponding to each of the plurality of constellation mapping signals of which the gain is controlled,
wherein the OFDM carrier signal comprises at least one OFDM sub-carrier signal that is modulated using high-order quadrature amplitude modulation (QAM).

4. The receiver of claim 3, wherein the gain controller comprises:
a power computing unit to compute the power of each of the plurality of constellation mapping signals; and
a gain adjusting unit to adjust the gain of each of the plurality of constellation mapping signals, based on a reciprocal value of a square root of the computed power of the received signal.

5. The receiver of claim 3, wherein the symbol determining unit selects a single symbol, among a plurality of predetermined symbols associated with the high-order QAM, that is most similar to each of the plurality of constellation mapping signals of which the gain is controlled, in order to determine a symbol corresponding to each of the plurality of constellation mapping signals of which the gain is controlled.

6. A method of manufacturing an automatic gain controlling device to be used in an orthogonal frequency division multiplexing (OFDM) receiver, the method comprising:
disposing a power computing circuit to receive an output signal of an OFDM receiving circuit;
disposing a gain computing circuit to receive an output signal of the power computing circuit; and
disposing a gain adjusting circuit to receive the output signal of the OFDM receiving circuit and an output signal of the gain computing circuit, and to be connected to an input end of a symbol determining circuit.

7. The method of claim 6, wherein
the power computing circuit computes a power of a received signal, based on the output signal of the OFDM receiving circuit,
the gain computing circuit computes a reciprocal value of a square root of the computed power of the received signal, based on the output signal of the power computing circuit, and
the gain adjusting circuit adjusts a gain of the received signal, based on the output signal of the OFDM receiving circuit and the output signal of the gain computing circuit.

8. The method of claim 6, wherein the output signal of the OFDM receiving circuit comprises a signal that is modulated using high-order quadrature amplitude modulation (QAM).
